(19) United States
(12) Patent Application Publication
(10) Pub. No.: US 2012/0110665 A1
(43) Pub. Date: May 3, 2012

(54) Intrusion Detection Within a Distributed Processing System

(75) Inventors: Anis M. Abdul, Austin, TX (US); Nicholas E. Bofferding, Austin, TX (US); Nikhil Hegde, Austin, TX (US); Ajay K. Mahajan, Austin, TX (US); Rashmi Narasimhan, Round Rock, TX (US)

(73) Assignee: International Business Machines Corporation, Armonk, NY (US)

(21) Appl. No.: 12/915,729

(22) Filed: Oct. 29, 2010

(51) Int. Cl. G06F 21/00

(52) U.S. Cl. 726/23

(57) ABSTRACT

A computer implemented method monitors activity within a device driver layer of a computer. An arrival rate is identified within a device driver for the node. The arrival rate is a rate at which packets arrive at a network adapter of the node from all other nodes within a network. If the arrival rate exceeds at least one threshold, the node undergoes a state change. The at least one threshold delineates between a plurality of states for the node.

### BACKGROUND

1. Field

The disclosure relates generally to a computer implemented method, a computer program product, and a data processing system. More specifically, the disclosure relates to a computer implemented method, a computer program product, and a data processing system for intrusion detection within a distributed processing system.

2. Description of the Related Art

The demand for large scale-out computing has fueled the need to have faster and larger computing systems. While processors continue to make advances on the speed front, the sheer amount of data that needs to be processed in large data centers requires highly efficient distributed processing. Also, in high-end servers the large number of processors is managed by several supporting processors such as the Flexible Service Processors in IBM pSeries systems, that work in a distributed fashion.

Companies now desire to place all of their computing resources on the company network. To this end, it is known to connect computers in a large, geographically-dispersed network environment and to manage such an environment in a distributed manner. One such management framework comprises a server that manages a number of nodes, each of which has a local object database that stores object data specific to the local node. Each managed node typically includes a management framework, comprising a number of management routines that is capable of a relatively large number (e.g., hundreds) of simultaneous network connections to remote machines. As the number of managed nodes increases, the system maintenance problems also increase, as do the vulnerabilities of the nodes within the system.

The problem is exacerbated in a typical enterprise as the node number rises. Of these nodes, only a small percentage are file servers, name servers, database servers, or anything but end-of-wire or “endpoint” machines. The majority of the network machines are simple personal computers (“PC's”) or workstations that see little management activity during a normal day.

In such a distributed environment, unwanted large bursts of traffic caused by either malicious activity or mis-configuration of the network can cause serious disruption of services provided by the computing system as a whole. There are several techniques available to detect such network activity in the protocol stack, but none are tailored specifically or take advantage of “neighbors” in a distributed system.

### SUMMARY

According to one embodiment of the present invention, a computer implemented method monitors activity within a device driver layer of a computer. An arrival rate is identified within a device driver for the node. The arrival rate is a rate at which packets arrive at a network adapter of the node from all other nodes within a network. If the arrival rate exceeds at least one threshold, the node undergoes a state change. The at least one threshold delineates between a plurality of states for the node.

### BRIEF DESCRIPTION OF THE SEVERAL VIEWS OF THE DRAWINGS

FIG. 1 depicts a pictorial representation of a network of data processing systems in which illustrative embodiments may be implemented;

FIG. 2 is an illustration of a data processing system depicted in accordance with an advantageous embodiment;

FIG. 3 is a data flow for data traffic monitoring and intrusion detection within a distributed system according to an illustrative embodiment;

FIG. 4 is a data flow for data traffic monitoring and intrusion detection of a specific compromised node according to an illustrative embodiment; and

FIG. 5 is a flowchart for alerting nodes within a distributed system of a potential compromise of a particular network node.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

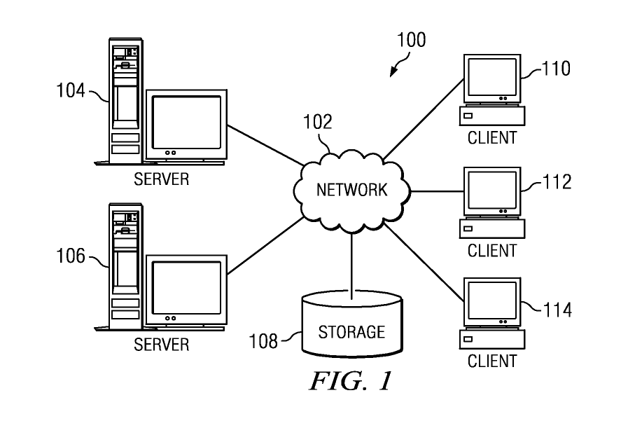

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

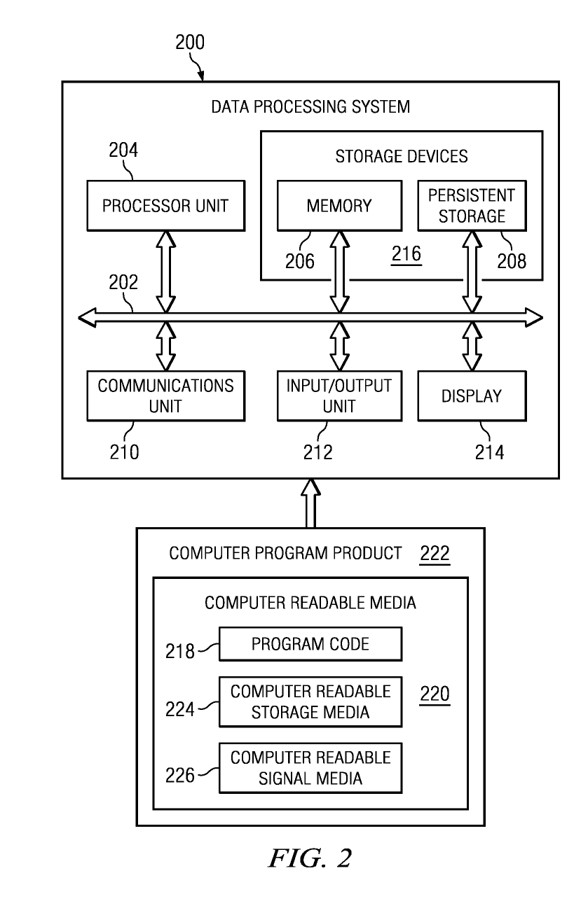

Turning now to FIG. 2, an illustration of a data processing system is depicted in accordance with an advantageous embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these illustrative examples, computer readable storage media 224 is a non-transitory computer readable storage medium.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communication links, such as wireless communication links, optical fiber cable, coaxial cable, a wire, and/or any other suitable type of communications link. In other words, the communications link and/or the connection may be physical or wireless in the illustrative examples.

In some advantageous embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different advantageous embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache, such as found in an interface and memory controller hub that may be present in communications fabric 202.

The illustrative embodiments herein provide a system for monitoring data traffic directed to a data processing system within a distributed processing environment. The data traffic is monitored using a Service Processor framework. The framework is provided on each computer in the Service Processor Environment. The framework is configured to receive device driver data traffic before the data is forwarded to a service processor for processing.

The illustrative embodiments monitor the data traffic using the framework to identify intrusions. The intrusion identification step includes associating data traffic with Service Processor Sessions. The sessions can be identified by session identifiers, device identifiers, and user identifiers. For example, Web Server Session identifiers for Service Processor HTTP Sessions, internet protocol address used by the originating device, MAC address of the originating device, and User information such as User Name or Logon Identification for each session of data traffic are sent to a Service Processor.

Upon identification of an Intrusion, the framework is used to filter identified intrusions before the data is forwarded to a Service Processor for processing.

The framework is additionally configured to send intrusion notifications to the other computers of the distributed processing environment. The notifications can be sent to the other computers on a different communications channel than the channel used for receiving data traffic. In this fashion, the framework shares information regarding data intrusion identification with the other computers of the distributed processing environment.

The illustrative embodiments herein provide a computer implemented method that monitors activity within a device driver layer of computer. An arrival rate is identified within a device driver for of the node. The arrival rate is a rate at which packets arrive at a network adapter of a node from all other nodes within a network. If the arrival rate exceeds at least one threshold, the node undergoes a state change. The at least one threshold delineates between a plurality of states for the node.

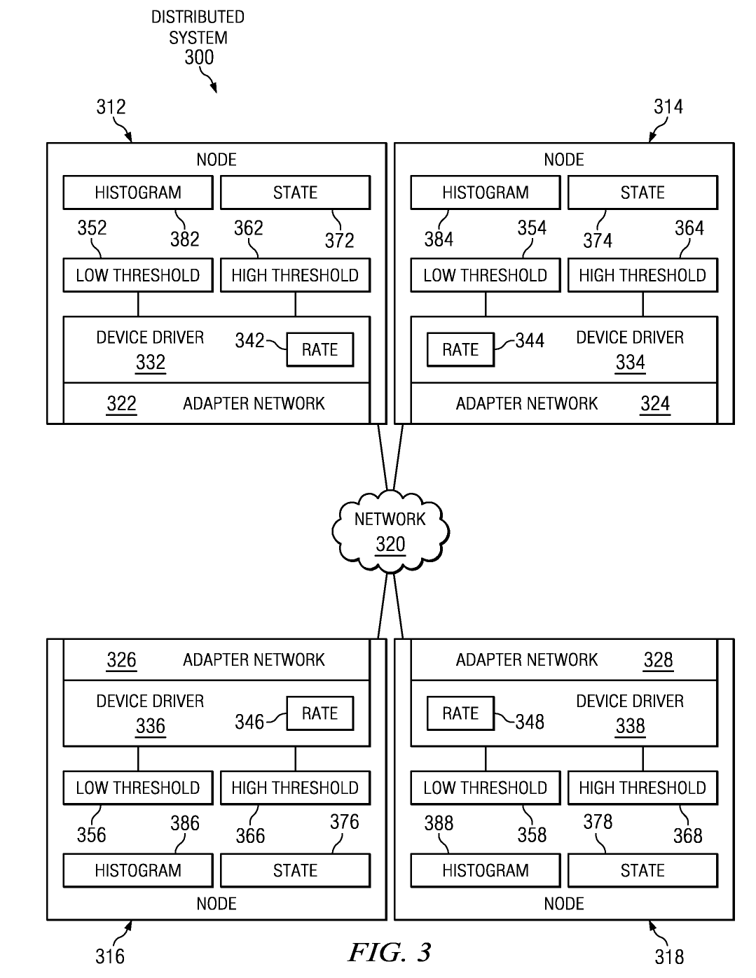

Referring now to FIG. 3, a data flow is shown for data traffic monitoring and intrusion detection within a distributed system according to an illustrative embodiment. Distributed system 300 consists of multiple nodes 312-318 that communicate through network 320. Nodes 312-318 can be, for example, one of server computer 104 and server computer 106 of FIG. 1, or one of client computers 110, 112, and 114 of FIG. 1. Network 320, can be for example, network 102 of FIG. 1.

Nodes 312-318 each include one of network adapters 322-328. Each of network adapters 322-328 is a hardware device, such as a network interface card, that handles an interface to a computer network and allows a network-capable device to access that network. Each of network adapters 322-328 includes a unique media access control (MAC) Address. The media access control address uniquely identifies the associated one of nodes 312-318 on the network. Network adapters 322-328 allow each of nodes 312-318 to communicate with other ones of nodes 312-318 over network 320.

Nodes 312-318 each include one of device drivers 332-338. Each of device drivers 332-338 is a is a software component that allows other software components executing on nodes 312-318 to interact with the associated one of network adapters 322-328.

Each of device drivers 332-338 maintains one of arrival rates 342-348. Arrival rates 342-348 is a decaying average of the rate at which packets arrive from all of the other nodes in the network, such as nodes 312-318, at the associated one of network adapters 322-328. A traditional average, wherein the mean weights all data equally, lacks sensitivity to the ordered nature of data streams. In contrast, a decaying average preferentially weighs data by its proximity to the present. With the decaying average, each bit of data enters the data stream and immediately begins decaying, and is thereby has less an impact on the decaying average as the bit of data becomes more remote in time.

Arrival rates 342-348 is a decaying average such that arrival rates 342-348 will drop if the rate at which packets arrive at an associated one of network adapters 322-328 remains constant over an extended period of time. A decaying average is used such that the potential impact of each successive piece of data utilized to compute arrival rates 342-348 is equalized. By utilizing a decaying average, packets arriving at a more recent time are given greater weight when calculating arrival rates 342-348 than are packets arriving at a more remote time. Arrival rates 342-348 do not distinguish the packets based on the source node from which the packet was sent, such as nodes 312-318.

Each of device drivers 332-338 has associated therewith, one of low thresholds 352-358, and one of high thresholds 362-368. Low thresholds 352-358 are thresholds that delineate when a state change for the associated one of nodes 312-318 should be executed. Low thresholds 352-358 delineate a state change between an IDLE state and a WATCH state. When one of arrival rates 342-348 exceeds the associated one of low thresholds 352-358, the associated state, such as one of states 372-378, is changed from an IDLE state to a WATCH state. Low thresholds 352-358 can be determined based on an average packet rate that is received at a node. Low thresholds 352-358 may also be entered by a system administrator. Low thresholds 352-358 may be measured as an amount of traffic received at a node, such as a number of packets received per second, or a number of bytes received per second. Low thresholds 352-358 can be, for example, but not limited to, 1000 packets per second, or 10 MB per second.

High thresholds 362-368 are thresholds that delineate when a state change for the associated one of nodes 312-318 should be executed. High thresholds 362-368 delineate a state change between a WATCH state and an ALARM state. When one of arrival rates 342-348 exceeds the associated one of high thresholds 362-368, the associated state, such as one of states 372-378, is changed from a WATCH state to an ALARM state.

States 372-378 are statuses of nodes 312-318 based on the corresponding one of arrival rates 342-348. States can be one of IDLE, WATCH, and ALARM. Nodes 312-318 perform different actions depending on the status that the corresponding one of states 372-378 is set to.

States 372-378 is initially set at IDLE. An IDLE state is a default state for one of nodes 312-318. An IDLE state is indicative that a corresponding one of arrival rates 342-348 does not exceed the associated one of low thresholds 352-358. When one of states 372-378 is set at IDLE, the corresponding one of device drivers 332-338 performs no special action, other than the continuous monitoring of the associated one of arrival rates 342-348.

When one of arrival rates 342-348 exceeds the associated one of low thresholds 352-358, the associated state, such as one of states 372-378, is changed from an IDLE state to a WATCH state. A WATCH state is a heightened surveillance state for one of device drivers 332-338. A WATCH state is indicative that a corresponding one of arrival rates 342-348 exceeds the associated one of low thresholds 352-358, but does not exceed the associated one of high thresholds 362-368.

When one of states 372-378 is set at WATCH, the corresponding one of device drivers 332-338 begins to store a corresponding one of histogram 382-388. Each of histograms 382-388 is a historical recording of the rate at which packets arrive from each of the other network nodes 312-318 at specific time intervals, over a determined time period. Each of histograms 382-388 is maintained as a decaying average, such that arrival rates are weighed more heavily than arrival rates that are more remote in time. Each of histograms 382-388 is maintained on a per node or per hash bucket basis.

Each of histograms 382-388 is maintained for one, or a subset of the total nodes in the network. In contrast to arrival rates 342-348 that does not distinguish between the origination of arriving packets, each of histograms 382-388 maintains the rate at which packets arrive from specific ones of other network nodes.

Because the number of nodes within network 320 is potentially very large, in one illustrative embodiment, each of histograms 382-388 is collected via a bifurcated, two-step process. During the first step of the process, each of histograms 382-388 is maintained across a set of hash buckets. Each hash bucket can include a plurality of network nodes, such as nodes 312-318. The hashing for each of nodes 312-318 can be based on either an internet protocol address for the node, a media access control address for the node, or a combination thereof. In one illustrative embodiment, the hashing for each of nodes 312-318 is based on a 4-byte internet protocol address for the node, a 6-byte media access control address for the node, or a 10-byte combination of the internet protocol address and the media access control address. Each hash bucket maintains a total count of packets received by ones of nodes 312-318 hashed to that particular hash bucket.

During the second step of the process, each of histograms 382-388 is maintained for each one of nodes 312-318 that are hashed to the particular hash bucket monitored in the first step. When a count within a hash bucket exceeds a certain hash count threshold, one of the associated device drivers 332-338 switches from the per hash bucket monitoring of the first step, to a per node monitoring of the second step. Thus, during the second step, a histogram, such as one of histograms 382-388, is separately calculated for each of nodes 312-318 that are hashed to the particular hash bucket.

In another illustrative embodiment, the number of steps in the hashing method exceeds 2. In a network with a large number of nodes, multiple hash levels can be employed in order to better manage the number of elements within each hash bucket. A histogram, such as one of histograms 382-388, could then be employed for each hash level. The hashing method then proceeds along each level of the hash until a particular node is located.

When one of arrival rates 342-348 exceeds the associated one of high thresholds 352-358, the associated state, such as one of states 372-378, a corresponding histogram, such as one of histograms 382-388, is checked to determine whether any individual nodes, such as one or more of nodes 312-318, has crossed a single node rate threshold. If a packet average rate from one or more sources, as determined from histograms 382-388, remains the same for an extended period of time and does not cross the single node rate threshold for an individual source, then the increase for the one of arrival rates 342-348 is declared as a false alarm. The associated state, such as one of states 372-378, is changed back to IDLE.

However, if a packet average rate from one or more sources, as determined from histograms 382-388, continues to rise and crosses the single node rate threshold, then the node's state is changed from a WATCH state to an ALARM state. An ALARM state is a heightened security state indicating that a potential attack has been identified at a particular node.

When one of states 372-378 is set at ALARM, the corresponding one of nodes 312-318 begins to take steps to mitigate the potential attack on network 320. When a node, such as one of nodes 312-318 enters an ALARM state, the ALARM node begins to send out a list of particular nodes that have been identified as crossing the single node rate threshold. The list is sent to other nodes, such as others of nodes 312-318, in network 320. In one illustrative embodiment, the list can be sent out on a pre-defined multicast address that all nodes in distributed system 300 joined at system startup. In another illustrative embodiment, the list can be sent out to a predefined TCP port on each of nodes 312-318. The node sending the list will also activate special internet protocol blocks in the device driver to prevent packets from particular nodes that have been identified as crossing the single node rate threshold from being processed.

By broadcasting the identity of the compromised node to other nodes within the network, the compromised node can be isolated, mitigating any damage to the network. Thus, once a particular node is identified as being compromised, other nodes in the network are informed of the attack, so that those other nodes do not accept traffic from the compromised node.

Other nodes, on receiving the information from the node in ALARM state, will take appropriate steps to safeguard against the potential attack. In one illustrative embodiment, the steps could be to have the corresponding device driver, such as one of device drivers 332-338, block the source media access control address for the particular nodes that have been identified as crossing the single node rate threshold. In another illustrative embodiment, the corresponding device driver, such as one of device drivers 332-338, can be modified to peek into the internet protocol header and block the internet protocol address for the particular nodes that have been identified as crossing the single node rate threshold. In another illustrative embodiment, operating system for a node could insert internet protocol filtering rules to block packets from the internet protocol address of the particular nodes that have been identified as crossing the single node rate threshold.

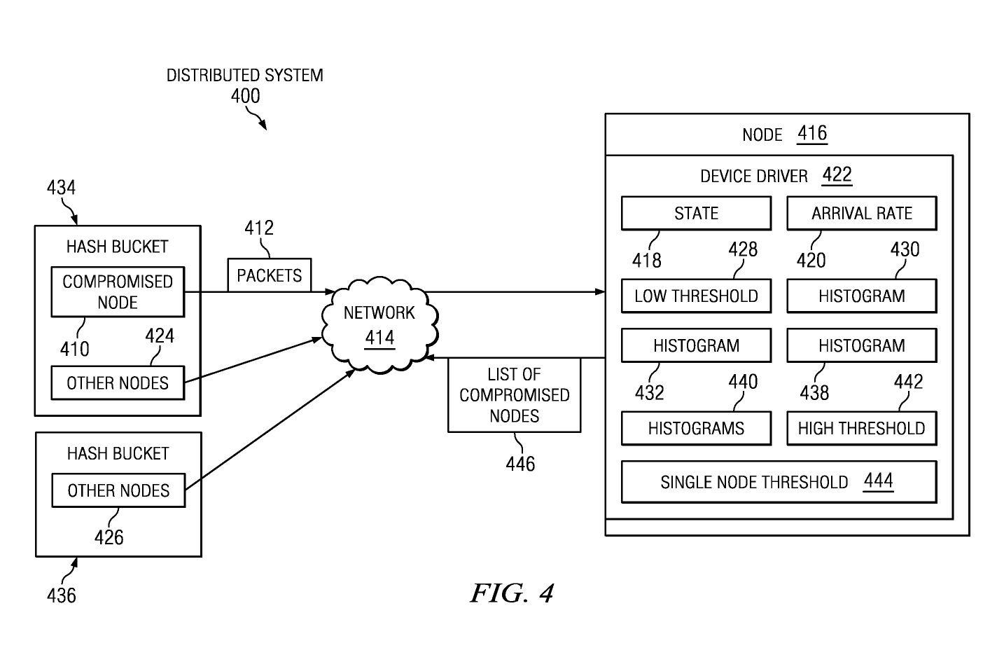

Referring now to FIG. 4, a data flow is shown for data traffic monitoring and intrusion detection of a specific compromised node according to an illustrative embodiment. Distributed system 400 is a distributed system, such as distributed system 300 of FIG. 3.

Distributed system 400 includes compromised node 410. Compromised node 410 is a node, such as one of nodes 312-318 of FIG. 3, whose functionality or security has been compromised. Compromised node 410 sends packets 412 across network 414 to node 416.

Node 416 is a node, such as one of nodes 312-318 of FIG. 3. State 418 for node 416 is initially IDLE. When node 416 initially receives one of packets 412, arrival rate 420 is updated. Arrival rate 420 is an arrival rate, such as one of arrival rates 342-348 of FIG. 3. Arrival rate 420 is maintained within device driver 422. Arrival rate 420 is a decaying average of the rate at which packets arrive from all of the other nodes in the network. That is, arrival rate 420 includes packets received not only from compromised node 410, but also from other nodes 424 and other nodes 426.

While State 418 is IDLE, arrival rate 420 is compared to low threshold 428. Low threshold 428 is a low threshold, such as one of low thresholds 352-358 of FIG. 3. Should arrival rate 420 exceed low threshold 428, device driver 422 changes state 418 from an IDLE state to a WATCH state.

Once node 416 is in the WATCH state, device driver 422 begins to store histogram 430 and histogram 432. Each of histogram 430 and histogram 432 can be one of histograms 382-388 of FIG. 3.

Each of histogram 430 and histogram 432 is maintained for a subset of the total nodes in the network, based on the hashing of network nodes to a particular hash bucket, such as either hash bucket 434 or hash bucket 436. Thus, histogram 430 is maintained for hash bucket 434, and histogram 432 is maintained for hash bucket 436. In contrast to arrival rate 420 that does not distinguish between the origination of arriving packets, each of histogram 430 and histogram 432 maintains the rate at which packets arrive from specific ones of other network nodes. Thus, histogram 430 maintains a combined rate at which packets arrive from compromised node 410 and other nodes 424. Similarly, histogram 432 maintains a combined rate at which packets arrive from other nodes 426.

If the rate of packets 412 for hash bucket 434 and hash bucket 436 as determined by histogram 430 and histogram 432 remains the constant for an extended period of time and does not exceed low threshold 428, then the increase for arrival rate of packets 412 is declared as a false alarm. State 418 is changed back to IDLE.

As arrival rate of packets 412 continues to rise, device driver 422 can determine from histogram 430 and histogram 432 which of hash bucket 434 and hash bucket 436 is responsible for the increased packet rate. Device driver 422 can then begin to maintain histogram 438 and histograms 440. Histogram 438 and histograms 440 are histograms, such as one of histogram 382-388 of FIG. 3. In contrast to histogram 430 and histogram 432 that were maintained per hash bucket, histogram 438 and histograms 440 are maintained for individual nodes of the network. Thus, histogram 438 is maintained for compromised node 410, while ones of histograms 440 are maintained for each of other nodes 424.

While state 418 is WATCH, arrival rate 420 is compared to high threshold 442. High threshold 442 is a high threshold, such as one of high thresholds 362-368 of FIG. 3. If arrival rate 420 exceeds high threshold 442, device driver 422 then compares histogram 438 and histograms 440, maintained for single nodes, to single node threshold 444. In the illustrative embodiment, the arrival rate of packets from compromised node 410 exceeds single node threshold 444. Device driver 422 therefore changes state 418 from a WATCH state to an ALARM state.

When state 418 is changed to ALARM, node 416 sends out list of compromised nodes 446 to other nodes 424 and other nodes 426. List of compromised nodes 446 indicates to other nodes 424 and other nodes 426 that compromised node 410 is suspected of being compromised. List of compromised nodes 446 can identify compromised node 410 based on either an internet protocol address of compromised node 410 or a media access control address of compromised node 410.

On receiving list of compromised nodes 446, other nodes 424 and other nodes 426 take appropriate steps to safeguard against the potential attack from compromised node 410. In one illustrative embodiment, the steps could be to have a corresponding device driver for other nodes 424 and other nodes 426, such as one of device drivers 332-338 of FIG. 3, block the source media access control address for compromised node 410. In another illustrative embodiment, the corresponding device driver for other nodes 424 and other nodes 426, such as one of device drivers 332-338 of FIG. 3, can be modified to peek into an internet protocol header for list of compromised nodes 446 and block the internet protocol address for compromised node 410. In another illustrative embodiment, an operating system for other nodes 424 and other nodes 426 could insert internet protocol filtering rules to block packets 412 from compromised node 410.

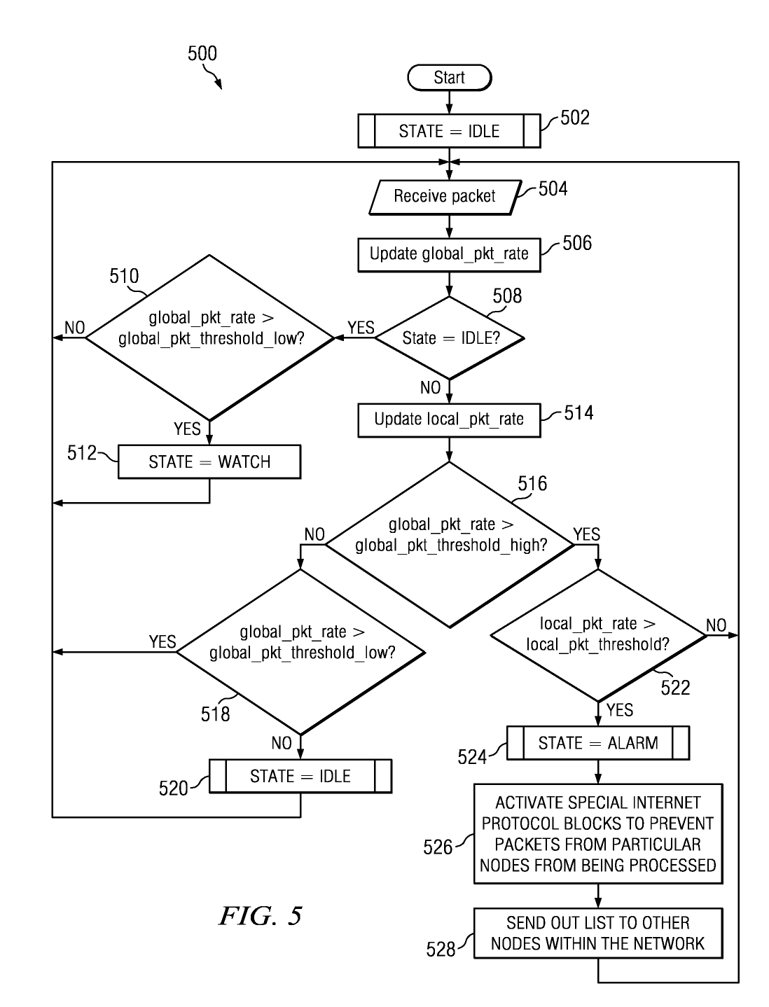

Referring now to FIG. 5, a flowchart is shown for alerting nodes within a distributed system of a potential compromise of a particular network node. Process 500 is a software process, executing within a software component, such as one of device drivers 332-338 of FIG. 3.

Process 500 begins by setting a state to IDLE (step 502). An IDLE state is a default state. An IDLE state is indicative that a corresponding arrival rates does not exceed an associated low threshold.

Process 500 then receives a packet (step 504). The packet can be packet 416 of FIG. 4. Responsive to receiving the packet, process 500 updates the global packet arrival rate (506). The arrival rate can be an arrival rate such as one of arrival rates 342-348 of FIG. 3.

Process 500 then identifies whether the state of the node is IDLE (step 508). Responsive to determining that the state of the node is IDLE (“yes” at step 508), process 500 then determines whether the arrival rate exceeds a low threshold for the node (step 510). The low threshold can be a low threshold such as low threshold 428 of FIG. 4. Responsive to determining that the arrival rate does not exceed a low threshold for the node (“no” at step 510), process 500 iterates back to step 504 and awaits the receipt of another packet. Responsive to determining that the arrival rate does exceed a low threshold for the node, (“yes” at step 510), process 500 sets the state to WATCH (step 512). A WATCH state is a heightened surveillance state for an associated device driver. Process then iterates back to step 504 and awaits the receipt of another packet.

Returning now to step 508, responsive to determining that the state of the node is not IDLE (“no” at step 508), process 500 updates a corresponding hash bucket histogram or single node histogram (step 514). The hash bucket histogram can be hash bucket histogram 430 of FIG. 4. The hash bucket histogram maintains a count of packets received from a sender node as well as packets received from ones of other nodes that hash to a same hash bucket as the sender node. The singe node histogram maintains a count of packets received only from a sender node.

Process 500 then determines whether the arrival rate exceeds a high threshold for the node (step 516). The high threshold can be a high threshold such as high threshold 436 of FIG. 4. Responsive to determining that the arrival rate does not exceed a high threshold for the node (“no” at step 516), process 500 then determines whether the arrival rate exceeds a low threshold for the node (step 518). Responsive to determining that the arrival rate does exceed a low threshold for the node (“yes” at step 518), process 500 iterates back to step 504 and awaits the receipt of another packet. Responsive to determining that the arrival rate does not exceed a low threshold for the node, (“no” at step 518), process 500 sets the state to IDLE (step 520). Process then iterates back to step 504 and awaits the receipt of another packet.

Returning now to step 516, responsive to determining that the arrival rate does not exceed a high threshold for the node (“yes” at step 516), process 500 then determines whether the corresponding hash bucket histogram exceeds a hash count threshold or single node histogram exceeds a single node threshold (step 522). Responsive to determining that the corresponding hash bucket histogram does not exceed a hash count threshold or the single node histogram does not exceed the single node threshold (“no” at step 522), process 500 iterates back to step 504 and awaits the receipt of another packet.

Responsive to determining that the corresponding hash bucket histogram does exceed a hash count threshold or the single node histogram does exceed the single node threshold (“yes” at step 522), process 500 sets the state to ALARM (step 524). An ALARM state is a heightened security state indicating that a potential attack has been identified at a particular node.

Responsive to setting the state to ALARM, process 500 then activates special internet protocol blocks to prevent packets from particular nodes from being processed (step 526). Process 500 then sends out list to other nodes within the network (step 528). The list can be list 440 of FIG. 4. The list indicates to other nodes in the network that a potential threat from a particular node has been identified. The list can identify the potential threat from the particular node based on either internet protocol address for the particular node, or media access control address for the particular node. Upon sending the list to other nodes within the network, process 500 iterates back to process 500 iterates back to step 504 and awaits the receipt of another packet.

The illustrative embodiments herein provide a system for monitoring data traffic directed to a data processing system within a distributed processing environment. The data traffic is monitored using a Service Processor framework. The framework is provided on each computer in the Service Processor Environment. The framework is configured to receive device driver data traffic before the data is forwarded to a service processor for processing.

The illustrative embodiments monitor the data traffic using the framework to identify intrusions. The intrusion identification step includes associating data traffic with Service Processor Sessions. The sessions can be identified by session identifiers, device identifiers, and user identifiers. For example, Web Server Session identifiers for Service Processor HTTP Sessions, internet protocol address used by the originating device, MAC address of the originating device, and User information such as User Name or Logon Identification for each session of data traffic are sent to a Service Processor.

Upon identification of an Intrusion, the framework is used to filter identified intrusions before the data is forwarded to a Service Processor for processing.

The framework is additionally configured to send intrusion notifications to the other computers of the distributed processing environment. The notifications can be sent to the other computers on a different communications channel than the channel used for receiving data traffic. In this fashion, the framework shares information regarding data intrusion identification with the other computers of the distributed processing environment.

The illustrative embodiments herein provide a computer implemented method that monitors activity within a device driver layer of computer. An arrival rate is identified within a device driver for of the node. The arrival rate is a rate at which packets arrive at a network adapter of a node from all other nodes within a network. If the arrival rate exceeds at least one threshold, the node undergoes a state change. The at least one threshold delineates between a plurality of states for the node.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for monitoring activity within a device driver layer of a computer, the method comprising:
identifying, by a device driver, an arrival rate, wherein the arrival rate is a rate at which packets arrive at a network adapter of a node from all other nodes within a network, wherein the arrival rate is determined within a device driver for the node;
responsive to identifying the arrival rate, determining, by the device driver, if the arrival rate exceeds at least one threshold, wherein the at least one threshold delineates between a plurality of states for the node; and
responsive to determining that the arrival rate exceeds the at least one threshold, changing, by device driver, a state of the node.

2. The computer implemented method of claim 1, wherein the arrival rate is a first arrival rate, and wherein the at least one threshold comprises a low threshold and a high threshold.

3. The computer implemented method of claim 2, the method further comprising:
responsive to determining that the first arrival rate exceeds the low threshold, changing, by the device driver, the state of the node from a default state to a heightened surveillance state; and
responsive to changing the state of the node from the default state to the heightened surveillance state, identifying, by the device driver, a plurality of second arrival rates, each of the plurality of second arrival rates being a rate at which packets arrive at the network adapter from at least one of the other nodes.

4. The computer implemented method of claim 3, wherein the plurality of second arrival rates are determined for a plurality of hash buckets, each of the plurality of hash buckets comprising at least one of the other nodes, the method further comprising:
responsive to changing the state of the node from the default state to the heightened surveillance state, determining, by the device driver, the plurality of second arrival rates, wherein each of the plurality of second arrival rates corresponds to one of the plurality of hash buckets; and
responsive to determining that one of the plurality of second arrival rates for a first hash bucket of the plurality of hash buckets exceeds a hash threshold, determining, by the device driver, a plurality of third arrival rates, wherein each of the plurality of third arrival rates corresponds to one of the at least one of the other nodes within the first hash bucket.

5. The computer implemented method of claim 1, wherein the arrival rate is a decaying average of the rate at which the packets arrive at the network adapter of the node from all other nodes within the network.

6. The computer implemented method of claim 2, the method further comprising:
responsive to determining that the first arrival rate exceeds the high threshold, changing, by the device driver, the state of the node from the heightened surveillance state to a heightened security state; and
responsive to changing the state of the node from the heightened surveillance state to the heightened security state, activating, by the device driver, internet protocol blocks to prevent the packets from a particular node from being processed.

7. The computer implemented method of claim 6, the method further comprising:
responsive to determining that the first arrival rate exceeds the high threshold, sending, by the device driver, a list to the other nodes within indicating that a potential threat from the particular node has been identified.

8. The computer implemented method of claim 7, wherein the list identifies the particular node based on at least one identification from a group consisting of an internet protocol address for the particular node, a media access control address for the particular node, or a combination thereof.

9. The computer implemented method of claim 1, wherein data traffic is monitored using a service processor framework within a service processor environment.

10. A computer program product for managing data comprising:
a computer readable storage medium;
program code, stored on the computer readable storage medium, for monitoring activity within a device driver layer of a computer, the computer program product comprising:
program code, stored on the computer readable storage medium, for identifying an arrival rate, wherein the arrival rate is a rate at which packets arrive at a network adapter of a node from all other nodes within a network, wherein the arrival rate is determined within a device driver for the node;
program code, stored on the computer readable storage medium, responsive to identifying the arrival rate, for determining if the arrival rate exceeds at least one threshold, wherein the at least one threshold delineates between a plurality of states for the node; and
program code, stored on the computer readable storage medium, responsive to determining that the arrival rate exceeds the at least one threshold, for changing a state of the node.

11. The computer program product of claim 10, wherein the arrival rate is a first arrival rate, and wherein the at least one threshold comprises a low threshold and a high threshold.

12. The computer program product of claim 11, the computer program product further comprising:
program code, stored on the computer readable storage medium, responsive to determining that the first arrival rate exceeds the low threshold, for changing the state of the node from a default state to a heightened surveillance state; and
program code, stored on the computer readable storage medium, responsive to changing the state of the node from the default state to the heightened surveillance state, for identifying a plurality of second arrival rates, each of the plurality of second arrival rates being a rate at which packets arrive at the network adapter from at least one of the other nodes.

13. The computer program product of claim 12, wherein the plurality of second arrival rates are determined for a plurality of hash buckets, each of the plurality of hash buckets comprising at least one of the other nodes, the computer program product further comprising:
program code, stored on the computer readable storage medium, responsive to changing the state of the node from the default state to the heightened surveillance state, for determining the plurality of second arrival rates, wherein each of the plurality of second arrival rates corresponds to one of the plurality of hash buckets; and
program code, stored on the computer readable storage medium, responsive to determining that one of the plurality of second arrival rates for a first hash bucket of the plurality of hash buckets exceeds a hash threshold, for determining a plurality of third arrival rates, wherein each of the plurality of third arrival rates corresponds to one of the at least one of the other nodes within the first hash bucket.

14. The computer program product of claim 10, wherein the arrival rate is a decaying average of the rate at which the packets arrive at the network adapter of the node from all other nodes within the network.

15. The computer program product of claim 11, the computer program product further comprising:
program code, stored on the computer readable storage medium, responsive to determining that the first arrival rate exceeds the high threshold, for changing the state of the node from the heightened surveillance state to a heightened security state; and
program code, stored on the computer readable storage medium, responsive to changing the state of the node from the heightened surveillance state to the heightened security state, for activating internet protocol blocks to prevent the packets from a particular node from being processed.

16. The computer program product of claim 15, the computer program product further comprising:
program code, stored on the computer readable storage medium, responsive to determining that the first arrival rate exceeds the high threshold, for sending a list to the other nodes within indicating that a potential threat from the particular node has been identified.

17. The computer program product of claim 16, wherein the list identifies the particular node based on at least one identification from a group consisting of an internet protocol address for the particular node, a media access control address for the particular node, or a combination thereof.

18. The computer program product of claim 10, wherein data traffic is monitored using a service processor framework within a service processor environment.

19. A data processing system comprising:
a memory having a computer program product encoded thereon for monitoring activity within a device driver layer of a computer;
a bus system connecting the memory to a processor; and
a processor, wherein the processor executes the computer program product:
to identify a first arrival rate, wherein the first arrival rate is a rate at which packets arrive at a network adapter of a node from all other nodes within a network, wherein the first arrival rate is determined within a device driver for the node;
responsive to determining that the first arrival rate exceeds a low threshold, to change a state of the node from a default state to a heightened surveillance state;
responsive to changing the state of the node from the default state to the heightened surveillance state, to identify a plurality of second arrival rates, each of the plurality of second arrival rates being a rate at which packets arrive at the network adapter from at least one of the other nodes;
responsive to determining that one of the plurality of second arrival rates exceeds a high threshold, to change the state of the node from the heightened surveillance state to a heightened security state; and
responsive to changing the state of the node from the heightened surveillance state to the heightened security state, to activate internet protocol blocks to prevent the packets from a particular node from being processed.

20. The data processing system of claim 19, wherein the processor further executes the computer program product:
responsive to changing the state of the node from the default state to the heightened surveillance state, to determine the plurality of second arrival rates, wherein each of the plurality of second arrival rates corresponds to one of a plurality of hash buckets;
responsive to determining that one of the plurality of second arrival rates for a first hash bucket of the plurality of hash buckets exceeds a hash threshold, to determine a plurality of third arrival rates, wherein each of the plurality of third arrival rates corresponds to one of the at least one of the other nodes within the first hash bucket; and
responsive to determining that one of the plurality of third arrival rates exceeds the high threshold, sending a list to the other nodes within indicating that a potential threat from the particular node has been identified.
